(19) United States
(12) Patent Application Publication
(10) Pub. No.: US 2014/0260102 A1
(43) Pub. Date: Sep. 18, 2014

(54) Screw compactor

(71) Applicants: Nick Ball, Leicester (GB); Terry Ward, Leicester (GB)

(72) Inventors: Nick Ball, Leicester (GB); Terry Ward, Leicester (GB)

(21) Appl. No.: 13/797,952

(22) Filed: Mar. 12, 2013

(51) Int. Cl. B65B 63/02; B30B 9/30

(52) U.S. Cl. CPC B65B 63/02; B30B 9/301; B30B 9/3089
USPC 53/439; 100/145; 53/529

(57) ABSTRACT

A system, apparatus, and method for managing recyclable materials are disclosed. In one embodiment, an apparatus is described, the apparatus comprising an inlet port for receiving the recyclable materials, a tube connected to the inlet port, an outlet port as part of the tube for expelling the recyclable materials, a screw blade mounted inside the tube and the inlet port along a tube longitudinal axis for moving the recyclable materials through the inlet port, the tube, and the outlet port, a motor coupled to the screw blade for rotating the screw blade, thereby moving the recyclable materials through the apparatus, and a receptacle installed onto the outlet port for receiving the recyclable materials.

### BACKGROUND

I. Field of Use

The present application relates generally to the recycling industry. More specifically, the present application is a system, device and method for managing particular types of waste or recyclable materials at a materials recovery facility.

II. Description of the Related Art

In the solid waste recycling industry, disc screens are commonly used to separate fiber material from plastic or metal containers, or to perform size separation of various materials. These disc screens typically comprise a plurality of rotating shafts with rubber or steel discs attached along the shaft, which act to separate the material from each other.

One problem with disk screens is that they tend to trap material on the exposed, rotating shaft, which becomes a major maintenance concern in modern material recovery facilities. In particular, film plastic, (trash bags, grocery bags, packaging film, etc.) is prone to wrapping. As such, sorters are often employed before disc screens to remove film plastics from the waste stream. In the past, film plastic would be dropped onto conveyors or through drop chutes. The difficulty with this is that it is often difficult to move film plastic in this manner, either by hand or belt conveyor, due to its light weight and tendency to act as a parachute.

Recently, “film vacuum” systems have been employed to make the handling of plastic film easier. Each of these systems consist of a hood above a sorting station into which a sorter can lift the film plastic. Suction within the hood grabs the film plastic and it is conveyed by air through ducting to its destination. This makes the plastic film both easier to handle and it gives the sorter a “third option” which keeps drop chutes on either side of him/her free for other commodities, making the sorter more efficient.

The state of the art in film vacuum design is to convey the film plastic to a vertical, closed door, manual baler, which then binds the plastic film into relatively small bales. The problem with this design is that these baling machines are expensive to purchase and often difficult to operate for plant personnel. The baler is typically located on the ground, far away from where personnel generally perform their duties, such as on another level or mezzanine. Often times the baler is neglected, causing film to build up within it and jam. This may cause all, or a portion of, the sorting operation to cease until the baler can be cleaned. In other facilities, the door of the baler is simply left open and un-compacted film materials are allowed to spill out onto the floor. This may result in greater downtime for the entire plant as the disc screens are no longer being protected from film plastic.

Thus, it would be desirable to manage such film plastic in an easier manner, without the shortcomings of the prior art.

### SUMMARY

A system, apparatus, and method for managing recyclable materials are disclosed. In one embodiment, an apparatus is described, the apparatus comprising an inlet port for receiving the recyclable materials, a tube connected to the inlet port, an outlet port as part of the tube for expelling the recyclable materials, a screw blade mounted inside the tube and the inlet port along a tube longitudinal axis for moving the recyclable materials through the inlet port, the tube, and the outlet port, a motor coupled to the screw blade for rotating the screw blade, thereby moving the recyclable materials through the apparatus, and a receptacle installed onto the outlet port for receiving the recyclable materials.

In another embodiment, a system is described for separating recyclable materials from a mixed stream of materials, comprising a filmatic hood for receiving the recyclable materials from the stream of materials, an air movement device for drawing the recyclable materials into the filmatic hood, ductwork for mechanical coupling of the filmatic hood to a screw compactor, and the screw compactor for receiving the materials and for expelling the recyclable materials into a receptacle mounted to a screw compactor output tube.

In yet another embodiment, a method is described for installing a receptacle over an output tube such that a majority of the receptacle is installed over the output tube, separating the recyclable materials from a stream of mixed waste and/or recyclable materials, providing the recyclable materials to an inlet port of a screw compactor, moving the recyclable materials through the screw compactor using a screw blade mounted inside of the screw compactor, expelling the recyclable materials out from the output and into the receptacle causing the receptacle to slide off of the output tube as it is filled with the recyclable materials, and causing compaction of the recyclable materials proportional to the rate at which the receptacle slides off of the output tube.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 illustrates one embodiment of a vacuum sorting system;

FIG. 2 is a perspective view of one embodiment of a screw compactor;

FIG. 3 is a top, plan view of the screw compactor shown in FIG. 2;

FIG. 4 is a side view showing how a receptacle is installed onto a portion of the screw compactor as shown in FIG. 2;

FIG. 5 is a side view showing an annular lip and retainer disposed on the end of a portion of the screw compactor of FIG. 2;

FIG. 6 is a side view of the screw compactor of FIG. 5 with a receptacle installed over the tube and the retainer placed over the receptacle;

FIG. 7 is a side view of the screw compactor and receptacle of FIG. 4, with the receptacle in a nearly-filled condition; and

FIG. 8 is a block diagram of one embodiment of a method for managing the removal of film materials from a stream of recyclable materials.

### DETAILED DESCRIPTION

The present disclosure relates to a screw compaction system, apparatus and method for managing recyclable materials in a materials recovery facility. The screw compaction system allows convenient, cost-effective management of the collection of certain types of recyclable materials. In one embodiment, the screw compaction system is specially designed to process film material, such as trash bags, grocery bags, packaging film, etc., from a mixed recycling stream. In other embodiments, other recyclable materials can be processed as well, such as paper, cardboard, P.V.C., and metal cans. In general, it is preferred that the recyclable materials are deformable, so that they may be compacted and occupy less space after compaction. The compaction system compresses the recyclable material as it is expelled into a elongated bag. Once a bag is full, it may be replaced in a matter of minutes with another, empty bag, as opposed to an hour or more in the case of a full, vertical baler. The bag can be replaced by a single person, rather than needing multiple people or a piece of equipment, such as a forklift, to perform bag replacement. Over time, a number of the “plastic sausages” can be placed into a large, auto-tie baler. The resulting bales from such a sophisticated, auto-tie baler are easier to handle and, advantageously, creates bales of “export dimensions” that can be easily loaded onto cargo trains or trucks for delivery to a secondary treatment facility.

The screw compaction system described herein typically costs less than a quarter of the capital expense of a typical closed door baler, and significantly reduces operating expenses as a result of energy savings and the lack of baling wire needed. It is also easier to operate and maintain, thus minimizing costly down time, while helping to keep the facility clean.

FIG. 1 illustrates one embodiment of a vacuum sorting system 100, comprising a sorting station 102, a number of filmatic hoods 104, ductwork 106, a material separator 108, a screw compactor 110, an air movement device 112, and an optional dust filter 114. In other embodiments, not all of the components shown in FIG. 1 are necessary for proper operation of vacuum system 100.

Vacuum system 100 is typically installed on the premises of a material recovery facility. One of the functions of vacuum system 100 is to remove lightweight materials from a stream of incoming, mixed stream of recyclable materials/waste and provide these materials in a convenient, condensed form for further processing. In particular, in one embodiment, one or more types of film, or film materials, are removed from the stream of recyclable/waste stream, such as trash bags, grocery bags, packaging film, etc. The removed films are provided to screw compactor 110, where they are compacted as they are expelled from screw compactor 110 into removable storage containers. In other embodiments, other types of recyclable materials are removed from the waste/recyclable stream of materials entering the material recovery facility, such as hard plastics, glass, paper, cardboard, P.V.C., and metal cans.

In one embodiment, a stream of mixed recyclable material/waste is provided to the sorting station 102, typically on a conveyer system that transports these materials to the sorting station 102 as they are received at a material recovery facility or recycling plant. The mixed recyclable material/waste typically comprises a wide variety of household and business waste, such as paper products, plastic containers, building materials, etc. In many instances, the mixed recyclable material/waste arrive at the material recovery facility in plastic garbage bags, which typically must be torn open by specialized machinery in order to access the recyclable material inside. The plastic garbage bag then becomes mixed with the rest of the materials, and is included in the mixed recyclable material/waste stream.

When the mixed recyclable material/waste stream arrives at sorting station 102, in one embodiment, facility workers manually inspect the mixed recyclable material/waste stream and remove any films from the stream. As noted above, the films may comprise one or more of trash bags, grocery bags, packaging film, or other types of lightweight material. The films are placed proximate to one of the filmatic hoods 104, where they are drawn into a series of ducts, or ductwork, duct system, etc. 106 by a suction created by air movement device 112. Air movement device 112 typically comprises an electric fan or blower capable of creating a suction force sufficient to drawn film materials through the filmatic hoods, given the number and diameter of the ducts 106.

In another embodiment, film material is removed from the mixed recyclable material/waste stream using purely mechanical methods, such as a machine that sucks lightweight materials from a mixed recyclable material/waste stream as it is tossed into the air. In yet another embodiment, a mixed recyclable material/waste stream is separated into heavy and light “fractions” by a blower that provides a high-pressure air stream to the mixed recyclable material/waste stream as it cascades from a conveyor belt. The lightweight materials are blown a further distance from the heavier materials, thereby allowing separation of such lightweight materials from heavier ones. At this point, a suction system may be used to separate film material from the lightweight stream of materials. Other mechanical systems are known to those skilled in the art.

In any case, in one embodiment, the film materials are provided to a material separator 108 which is used to separate film material from the air stream, created by air movement device 112, inside ductwork 106. In this embodiment, material separator 108 separates the film material from the air stream using means well-known in the art, such as one or more large, rotary valves coupled with one or more perforated screens. The film material is ejected in a downward path through chute 116 which is mechanically coupled to screw compactor 110, where it enters screw compactor 110 via an inlet port.

The screw compactor 110 receives the film materials and forces them to an outlet port, where a receptacle, such as an elongated bag, is secured. The film material is forced into the receptacle until it is full. Then, the receptacle may be replaced by another empty one, while the full receptacle may be transported to another portion of the materials recovery facility or to another facility. In one embodiment, a number of full receptacles may be provided to a large, auto-tie baler. The resulting bales from such a sophisticated, auto-tie baler are easy to handle and comply with “export dimensions” so that they can be easily loaded onto cargo trains or trucks for delivery to one or more secondary treatment facilities.

FIG. 2 is a perspective view of one embodiment of a screw compactor 110, comprising motor 200, output tube (or simply, “tube”) 202, screw blade 204, inlet port 206, and outlet port 210. Not shown in this view is a film receptacle that is normally installed onto tube 202 for collecting film materials, and a retainer and an annular lip used in another embodiment, discussed below. FIG. 3 is a top, plan view of the same embodiment of screw compactor 110 shown in FIG. 2 to better illustrate certain mechanical aspects. Although the screw compactor 110 is described in the following paragraphs as a device for processing film materials, it could also be used to process other recyclable materials, such as paper, cardboard, P.V.C., and metal cans.

In the embodiment shown in FIGS. 2 and 3, screw compactor 110 comprises a length of approximately 6 feet as measured along a longitudinal axis 218, with tube 202 equal to approximately 3.5 feet in length and the combination of motor 200 and inlet port 206 equal to approximately 2.5 feet in length. The outside diameter of tube 202 at outlet port 210 is approximately 18 inches, while the height of inlet port 206 is approximately 2.5 feet. Of course, any of these dimensions may be varied to achieve a larger, or more compact, design. Screw compactor 110 is typically made of metal parts that are bolted, welded, or otherwise joined together.

Chute 116 (not shown in FIG. 2 or 3) is normally attached to inlet port 206 via mechanical means such as bolts or screws. Film materials are typically gravity-fed into inlet port 206 within chute 116. Motor 200 comprises one of many available industrial motors, and can be driven by electrical energy or by fuel energy obtained from virtually any fuel source, such as gasoline, diesel, natural gas, propane, as well as others. The size of the motor is typically commensurate with the size of the screw compactor 100. In one embodiment, the motor comprises a single-phase, ½ HP AC motor. Alternatively, or in addition, the motor 200 is sized to provide enough rotational energy to rotate screw blade 204 at one or more predetermined rates when a significant amount of film material is present. The rate of rotation of screw blade 204 generally determines how quickly the film material can move through screw compactor 110. For example, at low speed, a volume of 5 cubic feet of film material may pass through screw compactor 110, while at high speed, 25 cubic feet of film material may pass. The throughput of material also depends on the mechanical design of tube 202 and screw blade 204. For instance, the diameter of tube 202 (and, therefore, screw blade 204), the angle of the blades, and the number of blades per inch or foot may all contribute to the material throughput rate.

Although motor 200 is shown directly attached to screw blade 204, in other embodiments, it may drive screw blade 204 indirectly via the use of a chain, belt, or other mechanical energy-transfer mechanism.

As shown in FIG. 4, during operation, a film receptacle 400 is installed over the end of tube 202 in order to collect film materials as they are passed through screw compactor 110. In one embodiment, receptacle 400 comprises an elongated bag, typically formed of plastic, polyethylene, or some other similar material. In another embodiment, the elongated bag is made of an elastic material. In either case, an inner diameter of receptacle 400 may be slightly smaller than the outside diameter of tube 202. In this embodiment, the diameter relationship between receptacle 400 and tube 202 enables receptacle 400 to fit snugly over outlet port 210. In one embodiment, most or all of receptacle 400 is pulled onto tube 202, as shown in FIG. 4. Then, as film material is processed through film compressor 110, receptacle 400 slides off of tube 202 at a predetermined rate as receptacle 400 is filled with film material. This embodiment has the added benefit of compacting the film material inside of receptacle 400 depending on the rate at which receptacle 400 slides off of tube 202. The rate at which receptacle 400 slides off of tube 202 is at least partially dependent on the friction between the inner surface of receptacle 400 and the outside surface of tube 202. Thus, the level of compaction of the film materials may be proportional to the friction between the inner surface of receptacle 400 and the outside surface of tube 202. As friction is increased, the amount of force necessary to push receptacle 400 off of tube 202 is increased, thus resulting in a greater compaction of the film materials against an interior surface of receptacle 400. The reciprocal is also true. The frictional force may increase by decreasing the diameter of receptacle 400 and/or by increasing the diameter of tube 202. The friction may also vary depending on the surface material of tube 202 and/or receptacle 400. In any case, the physical relationship between tube 202 and receptacle 400 may determine a rate at which receptacle 400 slides off of tube 202 and, as a result, an amount of compaction of the film material inside receptacle 400.

In another embodiment, the outside diameter of tube 202 is tapered such that it is larger in diameter at the discharge end of tube 202. In this embodiment, the enlarged diameter of tube 202 presents a particular force against receptacle 400, depending on the diameter of receptacle 400, that may impede the rate at which receptacle 400 slides off of tube 202 as material is expelled from tube 202.

In another embodiment, shown in FIG. 5, an annular lip 500 may be formed on the discharge end of the tube 202 to slow the rate at which film receptacle 400 slides off of tube 202. In yet another embodiment, an annular retainer 502 is used in conjunction with annular lip 500, again to decrease the rate at which receptacle 400 slides off of tube 202. In this embodiment, retainer 502 may abut the annular lip, as shown in FIG. 5. In yet still another embodiment, the retainer 502 may be used without annular lip 500. In another embodiment, an annular depression is formed at some point along the surface of tube 202 which is sized and shaped to accommodate a portion of retainer 502. In this embodiment, retainer 502 is at least partially seated within the annular depression over receptacle 400, thereby increasing the force necessary for retainer 502 to slide off of tube 202 as receptacle 400 is filled with film materials. The annular depression may be used alternatively, or in addition, to annular lip 500.

In use, after receptacle 400 is placed onto tube 202, retainer 502 is placed over the receptacle 400 and near the discharge end of tube 202 to increase the friction between tube 202 and receptacle 400 in order to achieve desired compaction results. Retainer 502 is typically formed of an elastic material and its diameter chosen to be somewhat smaller than the diameter of the discharge portion of tube 202. As a result, retainer 502 must be stretched over the discharge end of tube 202 and, when released, partially restrains receptacle 400 against tube 202. The design of retainer 502 may be based on a desired friction level that results from such design choices. For instance, the diameter and material of retainer 502 may be selected to provide a certain amount of friction between receptacle 400 and tube 202.

In another embodiment, retainer 502 comprises a hose clamp comprising a bolt that decreases the diameter of the hose claim as the bolt is tightened. In this embodiment, the amount of force between receptacle 400 and outlet port 210 may be varied, depending on how much the bolt is tightened, thus resulting in a variable compaction density of film material as it enters receptacle 400.

FIG. 6 is a side view of the screw compactor of FIG. 5 with a receptacle 400 installed over the tube 202 and the retainer 502 placed over the receptacle 400 to provide an annular force pressing receptacle 400 against an outer surface of tube 202. As materials enter receptacle 400, it is pushed off of tube 202 at a particular rate, which in turn causes a particular level of compaction of the materials as they enter receptacle 400.

Returning to FIGS. 2 and 3, film materials are provided to tube 202 via chute 116 and inlet port 206. The film materials then engage the rotating, helical blade of screw blade 204. The engagement of the film materials against the screw blade carries the film materials away from inlet port 206 towards outlet port 210. The screw blade 204 comprises a diameter that nearly matches a diameter of an inner surface of tube 202, which is typically cylindrical in nature. The film material exits the outlet port 210 and into receptacle 400. As discussed above, receptacle 400 typically comprises an elongated bag that is placed over outlet port 210 and, partially restrained by a retainer 502, annular lip 500, or a combination of both.

When receptacle 400 is nearly filled (as shown in FIG. 7), it may be replaced with another receptacle by a worker as needed. As discussed above, the amount of compaction of the film materials inside receptacle 400 may vary depending on a number of factors, such as the rotational speed of motor/screw blade 204, the inside diameter of tube 202/diameter of screw blade 204, the density of screw blade 204 (i.e., number of blades per inch, foot, etc.), the frictional force between receptacle 400 and outside of outlet port 210 depending on factors such as the material selection of receptacle 400 and/or the outside surface of tube 202, the diameter of receptacle 400 and/or tube 202, the use of a retainer 502 and its selected diameter and/or material selection, and/or the use of a lip 500 and/or depression. Receptacle 400 may then be bound at its open end and transported to another location of the materials recovery facility or to another location entirely. In one embodiment, a number of filled receptacles are provided to a large, auto-tie baler. The resulting bales from such a sophisticated, auto-tie baler are easier to handle and, advantageously, creates bales of “export dimensions” that can be easily loaded onto cargo trains or trucks for delivery to a secondary treatment facility.

FIG. 8 is a block diagram of one embodiment of a method for managing recyclable materials. It should be understood that in some embodiments, not all of the steps shown in FIG. 8 are performed and that the order in which the steps are carried out may be different in other embodiments. It should be further understood that some minor method steps have been omitted for purposes of clarity.

The method begins at block 800, where receptacle 400 is placed over tube 202. In one embodiment, receptacle 400 is placed over tube 202 such that a majority of the receptacle is installed over the output tube. The diameter of receptacle 400 may be chosen to form a friction fit between an inner diameter of receptacle 400 and an outer surface of tube 202.

At block 802, film materials are manually separated from a stream of mixed waste and/or recyclable materials using, in one embodiment, one or more filmatic hoods. A suction force is present at the input of the filmatic hood(s) that draw film materials through the hood(s) and into a duct system 106.

At block 804, the film materials are provided, via the duct system 106, to a material separator 108, where the film materials are separated from an air stream inside the duct system 106, created by air movement device 112. The film materials typically fall into a chute 116, as a result of gravitational forces.

At block 806, the film materials fall into input port 206 of screw compactor 110.

At block 808, the rotating action of screw blade 204 inside tube 202 moves the film materials along an axis along the length of tube 202.

At block 810, the film material is expelled out of the tube 202 via outlet port 210, where it enters receptacle 400.

At block 812, the film materials experience a compaction force against the receptacle 400 as a result of the friction fit between receptacle 400 and outlet port 210.

At block 814, after the receptacle has been filled, a worker removes receptacle 400 from outlet port 210 and seals an open end of receptacle 400 using known techniques such as binding. The worker may replace receptacle 400 with a second receptacle 400 on outlet port 210.

At block 816, after two or more receptacles 212 have been filled, the two or more receptacles 212 may be provided to an auto-baler for producing bales of compacted, film material having export dimensions suitable for transportation to secondary locations.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

I claim:

1. An apparatus for management of recyclable materials, comprising:
an inlet port for receiving the recyclable materials;
a tube connected to the inlet port;
an outlet port as part of the tube for expelling the recyclable materials;
a screw blade mounted inside the tube and the inlet port along a tube longitudinal axis for moving the recyclable materials through the inlet port, the tube, and the outlet port;
a motor coupled to the screw blade for rotating the screw blade, thereby moving the recyclable film materials through the apparatus; and
a receptacle installed onto the outlet port for receiving the recyclable film materials.

2. The apparatus of claim 1, wherein a friction force is created between an inner surface of the receptacle and an outer surface of tube, whereby the friction force causes the receptacle to slide off of the tube at a predetermined rate as it is being filled by the recyclable materials.

4. The apparatus of claim 2, wherein the friction force causes a compaction of the recyclable materials inside the receptacle.

5. The apparatus of claim 2, wherein a level of compaction of the recyclable materials is proportional to the rate at which the receptacle slides off of the tube.

6. The apparatus of claim 1, further comprising a retainer mounted over the receptacle and the tube for providing a frictional force between the receptacle and the tube.

7. The apparatus of claim 6, wherein the frictional force causes the receptacle to slide off of the tube at a rate that, in turn, causes a level of compaction of the recyclable materials.

8. The apparatus of claim 1, wherein the receptacle comprises an elongated bag having a diameter smaller than a diameter of the outlet port; wherein
the diameter is chosen to create a frictional force between the elongated bag and the outlet port, thereby causing a desired level of compaction of the recyclable material in the elongated bag.

9. A system for separating a particular type of recyclable material from a mixed stream of recyclable materials, comprising:
a filmatic hood for receiving the recyclable materials from the stream of recyclable materials;
an air movement device for drawing the recyclable materials into the filmatic hood;
ductwork for mechanical coupling of the filmatic hood to a screw compactor; and
the screw compactor comprising an inlet port, a tube, and a screw blade, for receiving the recyclable materials and for expelling the recyclable materials into a receptacle mounted over a discharge portion of the output tube.

10. The system of claim 8, wherein the receptacle comprises an elongated bag and is sized and shaped to form a frictional fit with the output tube.

11. The system of claim 10, wherein the friction fit causes the receptacle to slide off of the output tube at a predetermined rate as it is being filled by the recyclable materials.

12. The system of claim 10, wherein the friction fit causes a compaction of the recyclable materials inside the receptacle.

13. The system of claim 10, wherein a level of compaction of the recyclable materials is proportional to a rate at which the receptacle slides off of the tube as a result of being filled with the recyclable material.

14. The system of claim 9, further comprising a retainer mounted over the receptacle and the output tube for providing a frictional fit between the receptacle and the output tube.

15. The system of claim 14, wherein the frictional fit causes the receptacle to slide off of the tube at a rate that, in turn, causes a level of compaction of the recyclable materials.

16. A method for management of recyclable materials, comprising:
installing a receptacle over an output tube such that a majority of the receptacle is installed over the output tube;
providing the recyclable materials to an inlet port of a screw compactor;
moving the recyclable film materials through the screw compactor using a screw blade mounted inside of the screw compactor;
expelling the recyclable materials from an outlet port of the tube and into the receptacle causing the receptacle to slide off of the output tube as it is filled with the recyclable materials; and
causing compaction of the recyclable materials proportional to the rate at which the receptacle slides off of the output tube.

17. The method of claim 16, wherein the output tube comprises an annular lip, the method further comprising:
installing a retainer over the receptacle and the output tube, abutting the annular lip, thereby creating a frictional force between the receptacle and the output tube.
